(19) United States
(12) Patent Application Publication
(10) Pub. No.: US 2025/0210746 A1
(43) Pub. Date: Jun. 26, 2025

(54) ELECTRICAL SYSTEM

(71) Applicant: TOYOTA JIDOSHA KABUSHIKI KAISHA, Toyota-shi (JP)

(72) Inventors: Tomoaki SUZUKI, Nagoya-shi (JP); Tomoki Shinozaki, Tokyo (JP)

(73) Assignee: TOYOTA JIDOSHA KABUSHIKI KAISHA, Toyota-shi (JP)

(21) Appl. No.: 18/825,143

(22) Filed: Sep. 5, 2024

(30) Foreign Application Priority Data
Dec. 21, 2023 (JP) 2023-215630

(51) Int. Cl. H01M 10/637; H01M 10/615; H01M 10/625

(52) U.S. Cl. CPC H01M 10/637; H01M 10/615; H01M 10/625

(57) ABSTRACT

An electrical system comprises inverters, electrical circuitry, and a ECU. The electrical circuit includes a battery and a capacitor. When the temperature rise start condition for starting the temperature rise of the battery is satisfied, ECU performs frequency control for controlling the inverter so that the current frequency of the alternating current generated by the inverter becomes a set frequency related to the resonant frequency of the electric circuitry. ECU performs an update process of updating the set frequency so that the ripple of the current flowing through the electric circuitry increases when the frequency control is executed.

### CROSS-REFERENCE TO RELATED APPLICATION

This application claims priority to Japanese Patent Application No. 2023-215630 filed on Dec. 21, 2023, incorporated herein by reference in its entirety.

### BACKGROUND

### 1. Technical Field

The present disclosure relates to an electrical system.

### 2. Description of Related Art

Chinese Patent Application Publication No. 113085659 discloses a battery electric vehicle. This battery electric vehicle includes an inverter, a power storage device (battery), and a capacitor. The capacitor is provided between the power storage device and the inverter for current smoothing. In this battery electric vehicle, a current is supplied to the power storage device to increase the temperature of the power storage device by heat generation caused by inner resistance of the power storage device.

### SUMMARY

By controlling the inverter to forcibly resonate the electric circuit including the power storage device and the capacitor, the temperature of the power storage device can be increased by effectively generating heat.

The resonance frequency of the electric circuit may change due to a characteristic change (e.g., component variation or deterioration over time) of the electric circuit. In this case, the amount of heat generated in the power storage device may be smaller than expected when the temperature of the power storage device is increased by controlling the inverter as described above. As a result, the temperature of the power storage device cannot be increased effectively.

The present disclosure has been made to solve the above problem, and an object thereof is to flexibly cope with a change in the resonance frequency of an electric circuit including a power storage device and a capacitor and to effectively increase the temperature of the power storage device.

An electrical system of the present disclosure includes:
an inverter;
an electric circuit; and
a control device.
   The electric circuit includes a power storage device and a capacitor connected between a pair of power lines connecting the power storage device to the inverter.
   The control device is configured to perform frequency control for controlling the inverter to cause a current frequency of an alternating current generated by the inverter to be a set frequency related to a resonance frequency of the electric circuit when a temperature increase start condition for starting to increase a temperature of the power storage device is satisfied. The control device is configured to perform an update process for updating the set frequency to increase a ripple of a current flowing through the electric circuit when the frequency control is performed.

As the ripple increases, the amount of heat generated in the power storage device increases. As a result, the temperature of the power storage device can be increased effectively during the frequency control. With the above configuration, even when the resonance frequency deviates from the set frequency due to a change in the characteristic (resonance frequency) of the electric circuit and the amount of heat generated in the power storage device at the time of the frequency control decreases, the set frequency is updated (corrected) to increase the ripple. Thus, the ripple increases by the change in the current frequency, and therefore the amount of heat generated in the power storage device increases. As a result, the temperature of the power storage device can be increased effectively by flexibly coping with the change in the resonance frequency of the electric circuit.

According to the present disclosure, it is possible to effectively increase the temperature of the power storage device by flexibly coping with the change in the resonance frequency of the electric circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a vehicle equipped with an electrical system according to the present embodiment;

FIG. 2 is a diagram illustrating a relationship between the amount of heat generated by the battery and the ripple frequency during the ripple temperature increase control;

FIG. 3 is a diagram for explaining an example of a method for updating a set frequency;

FIG. 4A is a diagram for explaining a method of searching for a resonant frequency and updating a set frequency in a short time;

FIG. 4B is a diagram for explaining a method of searching for a resonant frequency and updating a set frequency in a short time;

FIG. 4C is a diagram for explaining a method of searching for a resonant frequency and updating a set frequency in a short time;

FIG. 5A is a flow chart illustrating a process executed by an Electronic Control Unit (ECU);

FIG. 5B is a flow chart illustrating a process executed by an Electronic Control Unit (ECU);

FIG. 6 is a diagram for describing an entire configuration of a vehicle according to a modification of the embodiment; and

FIG. 7 is a diagram for explaining a method of searching for a resonance frequency and updating a set frequency in Modification 1.

### DETAILED DESCRIPTION OF EMBODIMENTS

Hereinafter, an embodiment of the present disclosure will be described in detail with reference to the drawings. The same or corresponding parts in the drawings are denoted by the same reference numerals, and the description thereof will not be repeated.

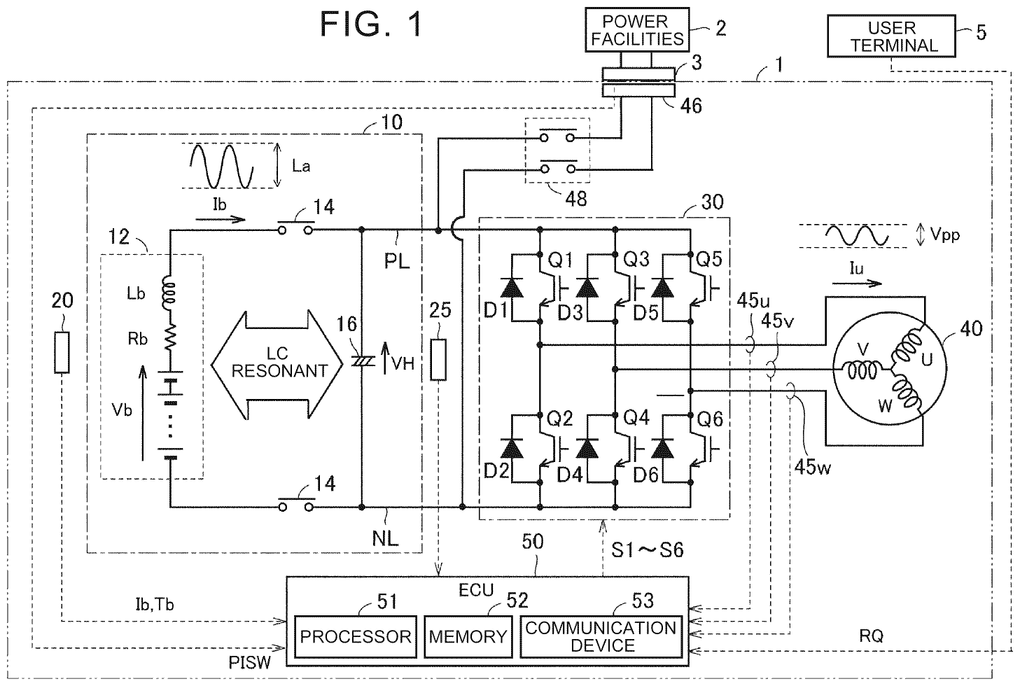

FIG. 1 is an overall configuration diagram of a vehicle in which an electrical system according to the present embodiment is mounted. Referring to FIG. 1, vehicles 1 are battery electric vehicle (BEV) and include electric circuit 10, a monitoring device 20, and a voltage sensor 25. The vehicle 1 includes an inverter 30, a motor 40, a 45w from the current sensor 45u, an inlet 46, a charge relay 48, and a ECU 50.

The electric circuit 10 includes a battery 12, a System Main Relay (SMR) 14, and a capacitor 16. The battery 12 is a secondary battery such as a lithium-ion battery, and corresponds to an example of a “power storage device” of the present disclosure. The battery 12 can be connected to the capacitor 16 and the inverters 30 (both of which will be described later) through an SMR 14. The reactor component, the internal resistance, and the electromotive force of the battery 12 are also referred to as “reactor component Lb”, “internal resistance Rb”, and “electromotive force Vb”, respectively. The direct current outputted from the battery 12 is also referred to as “current Ib”. When the temperature Tb of the battery 12 decreases, the performance of the battery 12 may decrease and the current Ib may decrease. In this case, there is a possibility that the vehicle 1 cannot travel a sufficient distance.

The electric circuit 10 has a resonant frequency (natural frequency). This frequency depends on the reactor components Lb and the capacitance of the capacitor 16. This capacitance may decrease with aging of the capacitor 16. At the above resonant frequency, the energy exchanged between the reactor components Lb and the capacitor 16 is maximized.

SMR 14 is connected to the battery 12. When SMR 14 is on, the battery 12 is connected to the capacitor 16 and the inverters 30. The capacitor 16 is connected between power line PL,NL (power line pairs). The power line PL,NL is provided to connect the battery 12 to the inverter 30. The capacitor 16 smoothes the current ripple (the ripple of the current Ib) superimposed on the power line PL, NL in accordance with the operation of the inverter 30.

The frequency and amplitude of the ripples described above are denoted as “ripple frequency” and “ripple amplitude La”, respectively. The ripple amplitude La is an example of an index indicating the magnitude of the ripple, and increases as the ripple frequency approaches a resonance frequency (hereinafter, also simply referred to as a “resonance frequency”) of the electric circuit 10. For example, when the ripple frequency matches the resonant frequency, the ripple amplitude La is maximized.

The monitoring device 20 is provided to monitor the state of the battery 12, and includes a current sensor and a temperature sensor (neither of which is shown). These sensors detect the current Ib and the temperature Tb of the battery 12, respectively. The voltage sensor 25 detects the voltage VH of the capacitor 16. The voltage VH corresponds to the voltage between the power lines PL,NL.

The inverters 30 include switching elements Q1 to Q6 and diodes D1 to D6. Q6 from the switching element Q1 is, for example, insulated-gate bipolar transistor (IGBT), but may also be metal-oxide-semiconductor field-effect transistor (MOSFET). The diodes D1 to D6 are provided in anti-parallel to the switching elements Q1 to Q6, respectively. The inverter 30 converts a direct current from the electric circuit 10 by switching Q6 from the switching element Q1 to generate an alternating current. The alternating current is a U-phase current (current Iu), a V-phase current, or a W-phase current of the motor 40.

The motor 40 is a permanent magnet synchronous motor connected to the inverter 30, and is capable of generating a traveling driving force of the vehicle 1 by receiving an alternating current from the inverter 30.

The current sensor 45u,45v,45w detects the U-phase current, the V-phase current, and the W-phase current of the motor 40, respectively. These currents are collectively referred to as “motor currents”. The peak to peak value of the respective motor currents is also expressed as “peak to peak value Vpp”. The peak to peak value Vpp is an exemplary index indicating the magnitude of the motor current. The frequency of the motor current is also referred to as the “motor current frequency”. Since the AC variation of the motor current appears as a current ripple on the DC-side of the inverter 30, the motor current frequency is equal to the ripple frequency of the current Ib.

The inlet 46 is connectable to a connector 3 of a power facility 2 external to the vehicle 1. The signal PISW is transmitted from the inlet 46 to ECU 50 (to be described later) as a signal representing a state of connection (connection/disconnection) between the inlet 46 and the connector 3. The charge relay 48 is provided in an electric path between the inlet 46 and SMR 14, and is controlled to be closed during external charging. External charging is charging the battery 12 using the feed power supplied from the power facility 2 through the inlet 46, the charge relay 48, and SMR 14. 25

ECU 50 includes a processor 51, memories 52, and a communication device 53. The processor 51 is, for example, a Central Processing Unit (CPU), and executes various arithmetic processes. The memories 52 include Read Only Memory (ROM) and Random Access Memory (RAM) (both not shown). ROM stores programs to be executed by the processor and various types of data. The data includes information indicating the travel distance and the number of years of use of the vehicle 1. The communication device 53 can receive the request RQ from the user terminal 5. The user terminal 5 is, for example, a smartphone, and can install an application for remotely operating a door (not shown) of the vehicle 1. The request RQ is transmitted from the user terminal 5 to the vehicle 1 when a user manipulation for unlocking the door is performed by the user using the application. The request RQ may be automatically transmitted when the distance between the user terminal 5 and the vehicle 1 becomes less than the predetermined distance.

ECU 50 controls the inverters 30. Specifically, ECU 50 generates a S6 from the drive signal S1 in accordance with the detection result of the monitoring device 20, the voltage sensor 25, and the current sensor 45u,45v,45w, and thereby controls on/off of Q6 from the switching element Q1. The drive signal Sk (1≤k≤6) is a signal for driving the switching element Qk, and is inputted to the gate of the switching element Qk (1≤k≤6).

ECU 50 raises the temperature of the battery 12 by executing the frequency control when the temperature rise start condition for starting the temperature rise of the battery 12 is satisfied. The frequency control is to control the inverter 30 so that the motor current frequency becomes a set frequency (hereinafter, also simply referred to as “set frequency”) related to the resonance frequency. In the following description, the set frequency is preferably the resonance frequency itself from the viewpoint of raising the temperature of the battery 12, but the temperature of the battery 12 is effectively raised even at a frequency near the resonance frequency (for example, a frequency within a predetermined range from the resonance frequency). The temperature rise starting condition is, for example, that the connector 3 is connected (inserted) to the inlet 46 and the temperature Tb is lower than a predetermined threshold temperature. ECU 50 stores, in the memory 52, a counter value indicating the number of times the temperature rise is started.

According to the above frequency control, since the motor current frequency approaches (including coinciding with) the resonant frequency, the ripple frequency also approaches the resonant frequency, thereby increasing the ripple amplitude La. Consequently, the power dissipation caused by the internal resistive Rb increases, the amount of heat generated by the battery 12 increases, and the battery 12 is warmed from the inside. Therefore, it is possible to avoid degradation in the performance of the battery 12 caused by the reduction in the temperature Tb. Hereinafter, the above-described frequency control is also referred to as “ripple temperature rise control”. In the embodiment, the ripple temperature rise control is executed so that the torque of the motor 40 becomes zero (for example, the d-axis current of the motor 40 becomes constant and the q-axis current becomes zero). The set frequency corresponds to a target frequency of the motor current frequency at the time of ripple temperature rise control.

ECU 50 calculates an amplification factor af of the ripple amplitude La with respect to the peak to peak value Vpp according to the detection result of the monitoring device 20 and the current sensor 45u,45v,45w. The closer the ripple frequency (motor current frequency) is to the resonant frequency, the higher the gain af. For example, when the ripple frequency coincides with the resonant frequency, the amplification factor af is highest, and the amount of heat generated by the battery 12 at the time of temperature increase is maximized. The amplification factor af will be described in detail later. Electric circuit 10, inverters 30, and ECU 50 are exemplary of the “electric system” disclosed herein.

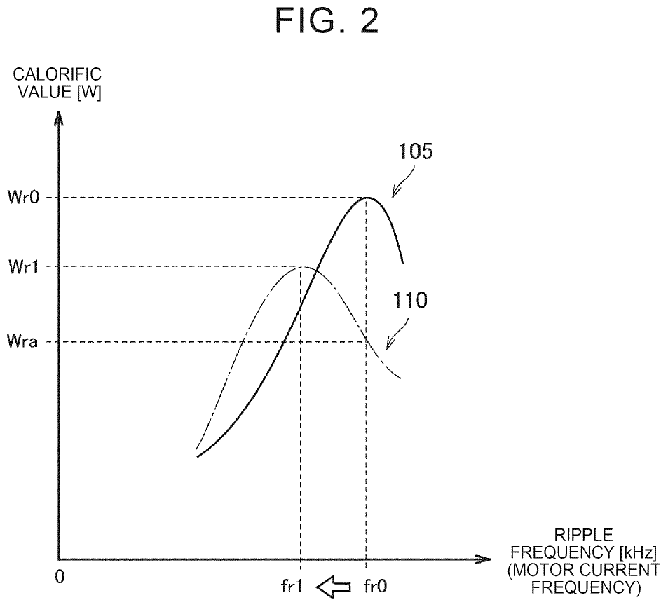

FIG. 2 is a diagram illustrating a relationship between the amount of heat generated by the battery 12 and the ripple frequency during the ripple temperature increase control. This relation is based on the assumption that the peak to peak value Vpp of the motor current is constant.

Referring to FIG. 2, a line 105 represents the relationship between the amount of heat generated and the ripple frequency estimated at the design stage of the vehicle 1. This relationship is determined in advance by pre-evaluation or the like. A line 110 represents the relationship between the heating value and the ripple frequency actually measured after the manufacture of the vehicle 1. This relationship is derived at a predetermined timing after manufacture of the vehicle 1 (in this example, when the vehicle 1 transitions to its maintenance mode during maintenance at the dealer prior to delivery to the customer). The transition to the maintenance mode is a procedure performed before the maintenance of the vehicle 1 is performed by a worker such as a dealer mechanic. Line 110 does not match line 105 due to variations in the performance of the components of electric circuit 10 (in this example, the capacitance of capacitor 16).

The reference frequency fr0 is a frequency at which the calorific value is maximized (Wr0) at the line 105, and corresponds to the resonant frequency at the designing stage. In this example, the reference frequency fr0 is determined in the design stage according to a calculation equation including the design values of the reactor components Lb and the capacitance of the capacitor 16 as parameters, and is stored in the memories 52 as the default values of the set frequencies described above. The reference frequency fr1 is a frequency at which the calorific value is maximized (Wr1) in the line 110, and corresponds to, for example, an actual resonant frequency at the time of maintenance of the vehicle 1.

As described above, since the resonance frequency may be changed due to variations in components of the electric circuit 10 or the like, the actual resonance frequency does not necessarily coincide with the reference frequency fr0 in the designing stage. For example, when the relation between the calorific value and the ripple frequency is represented by the line 110, if the ripple temperature increase control is executed using the set frequency as the reference frequency fr0 (calorific value: Wra), since the set frequency deviates from the actual resonant frequency (reference frequency fr1), there is a possibility that the temperature of the battery 12 cannot be effectively increased. As a result, the ripple temperature rise control may be prolonged.

Therefore, in the present embodiment, ECU 50 has a configuration for addressing such issues. Specifically, ECU 50 performs an update process of updating the set frequency so that the ripple of the current flowing through the electric circuit 10 increases (for example, so that the ripple amplitude La increases) when the ripple temperature rise control is executed. ECU 50, in this instance, preferably updates the set frequency from the reference frequency fr0 to the reference frequency fr1.

The larger the ripple amplitude La, the larger the amount of heat generated by the battery 12. As a result, the temperature of the battery 12 can be effectively increased during the ripple temperature increase control. With the above configuration, the set frequency is updated (corrected) so that the current ripple of the electric circuit 10 during the ripple temperature rise control increases. As a result, the motor current frequency (ripple frequency) at the time of the ripple temperature rise control changes and the ripple amplitude La increases, so that the amount of heat generated by the battery 12 increases from Wra to (for example, Wr1). As a result, the temperature of the battery 12 can be increased effectively by flexibly coping with changes in the resonance frequency. Therefore, it is possible to avoid a situation in which the ripple temperature increase control is prolonged.

It is preferable that ECU 50 updates the set frequency from the reference frequency fr0 to the reference frequency fr1, but the set frequency may be updated to a frequency higher than the reference frequency fr1 and lower than the reference frequency fr0. Also in this case, the calorific value can be increased from Wra.

In the present embodiment, the updating process is performed such that the amplification factor af of the ripple amplitude La with respect to the peak to peak value Vpp increases.

As described above, the higher the amplification factor af, the closer the motor current frequency (ripple frequency) is to the resonant frequency. Therefore, according to the above-described updating process, the ripple frequency approaches the resonant frequency, and the ripple amplitude La increases. As a result, the temperature of the battery 12 can be effectively increased.

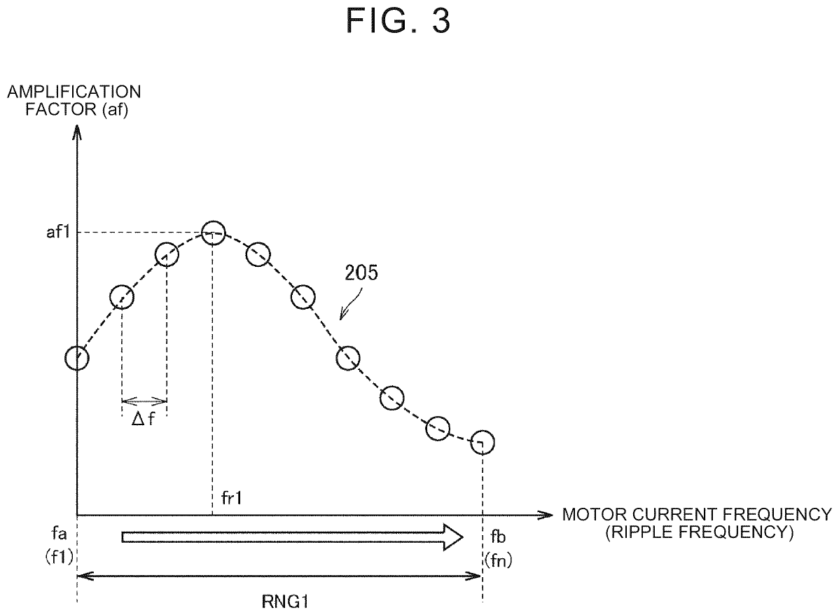

FIG. 3 is a diagram for explaining an example of a method for updating a set frequency. Referring to FIG. 3, the frequency range RNG1 is determined in advance by experimentation or the like as a range of values that can be taken by the motor current frequency, and in this embodiment, is a range from fa to fb.

ECU 50 first scans (sweeps) the motor current frequency within the frequency range RNG1 by controlling the inverters 30. Specifically, ECU 50 controls the inverters 30 so that the respective phase currents flow through the motor 40 while changing the motor current frequency at the interval Δf within the frequency range RNG1.

ECU 50 performs a first search process of searching for a reference frequency fr1 that is a motor current frequency at which the gain af is maximized in the frequency range RNG1 by scanning the motor current frequency as described above. Specifically, ECU 50 calculates an amplification factor af at each of a plurality of frequencies (f1, . . . fn) in the frequency range RNG1, derives a correspondence relation (line 205) between the calculation result and these frequencies, and searches for a reference frequency fr1 from the calculation result. ECU 50 stores the correspondence as the resonant property of the electric circuit 10 at an early stage of the vehicle 1 (e.g., during maintenance at a dealer prior to delivery) in the memory 52. The reference amplification factor af1 corresponds to the reference frequency fr1 on line 205, and specifically is the amplification factor af that is maximized at the reference frequency fr1 on line 205.

ECU 50 performs, as the above-described updating process, a first updating process of updating the set frequency at the time of executing the ripple temperature increase control from the reference frequency fr0 (FIG. 2) to the reference frequency fr1 in accordance with the outcome of the first searching process. The first search process and the first update process are executed, for example, when these processes are instructed during the maintenance mode of the vehicle 1.

When the motor current frequency is a resonant frequency, the gain af is maximal and the ripple amplitude La is maximal. Thus, the reference frequency fr1 corresponds to the actual resonant frequency of the electric circuit 10 during maintenance of the vehicle 1. According to the first search process and the first update process, the reference frequency fr1 is reliably searched as the resonance frequency even when the set frequency deviates from the actual resonance frequency due to component variation or the like of the electric circuit 10 (for example, when the set frequency is the reference frequency fr0 despite the actual resonance frequency being the reference frequency fr1), and the set frequency is updated to this frequency. This ensures that the amplification factor af is maximized and the ripple amplitude La is maximized during the ripple temperature rise control. Therefore, the temperature of the power storage device can be reliably increased.

After the set frequency is updated to the reference frequency fr1 by the first updating process, the resonant frequency may further change when the capacitance of the capacitor 16 or the like decreases due to aging of the electric circuit 10. Therefore, when the set frequency remains in the reference frequency fr1 for a long period of time, the resonant frequency may further change from the reference frequency fr1, and thus the ripple temperature rise control may not be effectively executed. Therefore, it is preferable that the set frequency is further updated at a specific timing after the first update process.

After the set frequency has been updated once by the first updating process, the resonant frequency is often not far from the reference frequency fr1 because it is unlikely that the resonant frequency will change significantly from the reference frequency fr1 in a short period of time. Therefore, if the first search process is performed in the frequency range RNG1 at all times for updating the set frequency, the time required for searching for the resonant frequency may be unnecessarily increased.

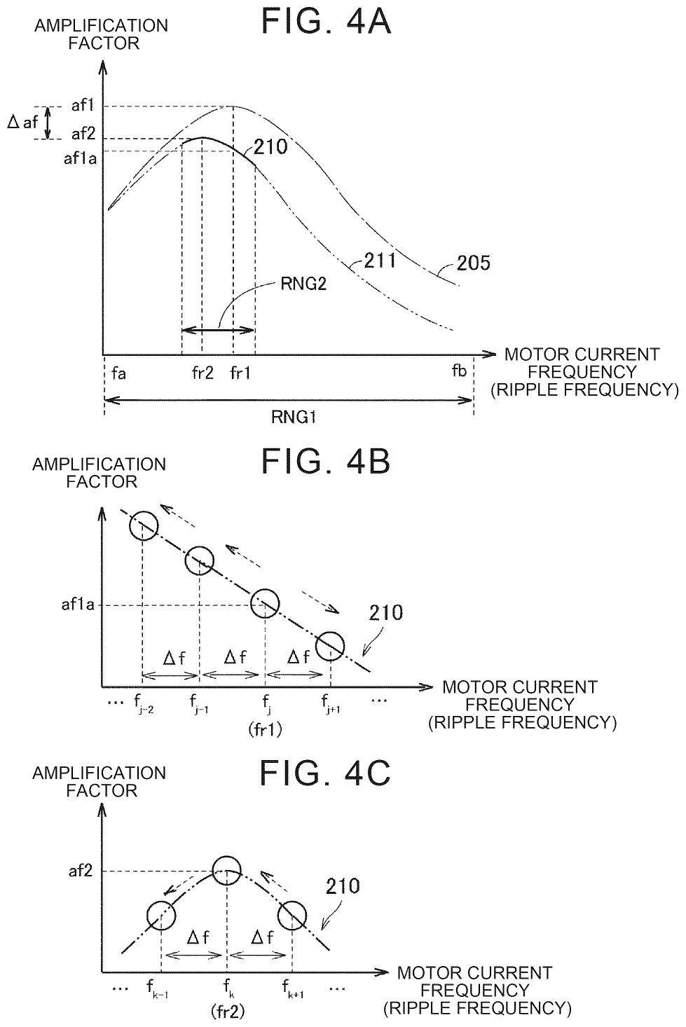

FIGS. 4A to 4C are each a diagram illustrating a method of searching for a resonant frequency and updating a set frequency in a short time. Referring to FIG. 4A, line 205 is the same as that shown in FIG. 3.

In the embodiment, ECU 50 executes the second search process and the second update process after the first search process and the first update process. The second search process is a process of scanning the motor current frequency within the frequency range RNG2 to search for a reference frequency fr2 that is a motor current frequency at which the gain af is maximized in the frequency range RNG2. The frequency range RNG2 is a frequency range in the vicinity of the reference frequency fr1, specifically, a range including the reference frequency fr1 and narrower than the frequency range RNG1. Since the frequency range RNG2 is narrower than the frequency range RNG1, the execution time of the second search process is shorter than the execution time of the first search process (FIG. 3).

In the second search process, ECU 50 calculates an amplification factor af at each of a plurality of frequencies in the frequency range RNG2, derives a correspondence relation (line 210) between the calculation result and these frequencies, and searches for a reference frequency fr2 from the calculation result. ECU 50 stores the correspondence as the resonating property after degradation of the electric circuit 10 in the memories 52. The reference amplification factor af2 corresponds to the reference frequency fr2 on line 210, and specifically is the amplification factor af that is maximized at the reference frequency fr2 on line 210. The reference amplification factor af2 is lower than the reference amplification factor af1 by Δaf. Line 211 represents the actual resonant property after degradation of the electric circuit 10 within the frequency-range RNG1.

After the second search process, ECU 50 executes the second update process of updating the set frequency from the reference frequency fr1 to the reference frequency fr2 as the above-described update process so that the ripple amplitude La at the time of the ripple temperature rise control increases (in this case, it is maximized).

According to the second search process and the second update process, after the set frequency is updated once in the reference frequency fr1 by the first update process, the reference frequency fr2 is searched for in the frequency range RNG2, and the set frequency is updated to the frequency. Thus, even when the resonance frequency changes from the reference frequency fr1 due to the aging deterioration of the electric circuit 10 after the first updating process, the reference frequency fr2 is accurately searched for as the resonance frequency after the aging deterioration of the electric circuit 10 in a short time, and the temperature of the battery 12 can be appropriately raised by the ripple temperature raising control.

Thereafter, ECU 50 periodically searches for the resonant frequency and updates the set frequency. For example, if the counter value reaches the threshold value after the second search process and the second update process, ECU 50 searches the resonant frequency again and updates the set frequency to the searched frequency. Thus, even when the resonance frequency changes from the reference frequency fr2 to another frequency, the temperature of the battery 12 can be increased effectively during the ripple temperature increase control by flexibly coping with the change in the resonance frequency. The threshold value can be set as appropriate.

Hereinafter, a specific procedure of the second search process will be described. Also in this case, it is assumed that the set frequency remains at the reference frequency fr1 while the resonant frequency changes from the reference frequency fr1 to the reference frequency fr2 due to the aging degradation of the electric circuit 10 after the first updating process.

Referring to FIG. 4B, ECU 50 first controls the inverters 30 to change the motor current frequency from the reference frequency fr1 (=f(j)). ECU 50, for example, pulls the motor current frequency from f(j) to f(j−1). ECU 50 determines that the gain af has risen from af1a, thereby further lowering the motor current frequency from f(j−1) to f(j−2). Thereafter, ECU 50 repeats the same process and continues to lower the motor current frequency by the distance Δf as long as the gain af increases.

Note that ECU 50 may first raise the motor current frequency from f(j) to f(j+1). ECU 50 then determines that the gain af has dropped from af1a, thereby reversing the frequency change direction and changing the motor current frequency from f(j+1) to f(j−1). The subsequent processing is as described above.

Referring to FIG. 4C, ECU 50 determines that the gain af has increased by lowering the motor current frequency from f(k+1) (<f(j−2))) to f(k). ECU 50 then lowers the motor current frequency from f(k) to f(k−1) to determine that the gain af has decreased. Accordingly, ECU 50 determines that the positive and negative of the rate of change of the gain af are reversed before and after f(k). ECU 50 determines that the gain af is the largest at f(k), and determines that the resonant frequency after aging degradation of the electric circuit 10 is f(k). ECU 50 ends the second search process using f(k) determined as the resonant frequency as the reference frequency fr2. Note that the method of the resonance-frequency search process executed after the second search process is also the same as the method in FIGS. 4B and 4C.

In the above description, the interval between the frequencies is equal to the interval Δf (FIG. 3), but may be different from the interval Δf.

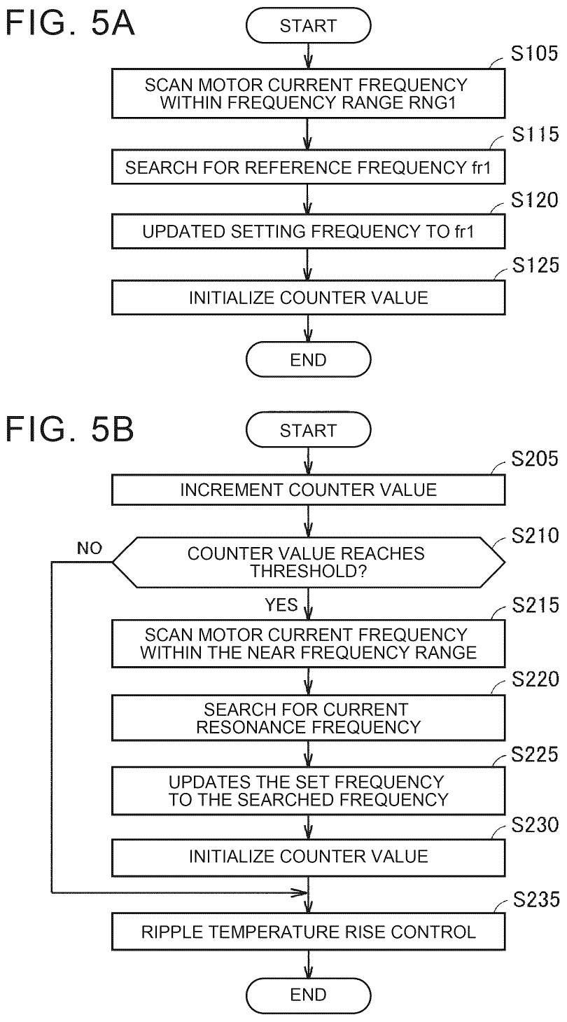

FIGS. 5A and 5B are each a flow chart illustrating a process executed by ECU 50. Hereinafter, the step is abbreviated as “S”.

Referring to FIG. 5A, this flow chart is started when the mode of the vehicle 1 transitions to the maintenance mode. ECU 50 scans (S105) the motor current frequency within the frequency-range RNG1 and thereby S115 the reference frequency fr1. ECU 50 updates the set frequency at the time of ripple temperature rise control from the reference frequency fr0 to the reference frequency fr1 (S120). ECU 50 initializes the aforementioned counters (S125). Thereafter, the process ends.

Referring to FIG. 5B, this flow chart is started after S125 and when the temperature rise start condition is satisfied. ECU 50 increments the counter value (S205) and determines whether the counter value has reached a threshold (S210). If the counter value has not yet reached the threshold (NO in S210), the process proceeds to S235. If the counter value reaches the threshold (YES in S210), the process proceeds to S215.

ECU 50 scans the motor current frequency within a frequency range in the vicinity of the current set frequency (S215). This frequency range is, for example, a frequency range RNG2. ECU 50 searches for the motor current frequency at which the gain af is maximized in the frequency range in the vicinity as the current resonant frequency (S220). The frequency is, for example, a reference frequency fr2. ECU 50 updates the set frequency to the searched frequency (S225) and initializes the counter value (S230). Thereafter, ECU 50 executes ripple temperature rise control (S235). Thereafter, the process ends.

As described above, according to the embodiment, the set frequency is updated (corrected) so that the amplification factor af increases even when the resonant frequency deviates from the set frequency at the present time due to the characteristic change (for example, component variation or aging degradation) of the electric circuit 10. Accordingly, since the ripple frequency approaches the resonant frequency, the ripple amplitude La increases and the amount of heat generated by the battery 12 increases. As a result, the temperature of the battery 12 can be increased effectively by flexibly coping with changes in the resonance frequency. Therefore, it is possible to avoid a situation in which the ripple temperature increase control is prolonged.

### First Modified Example

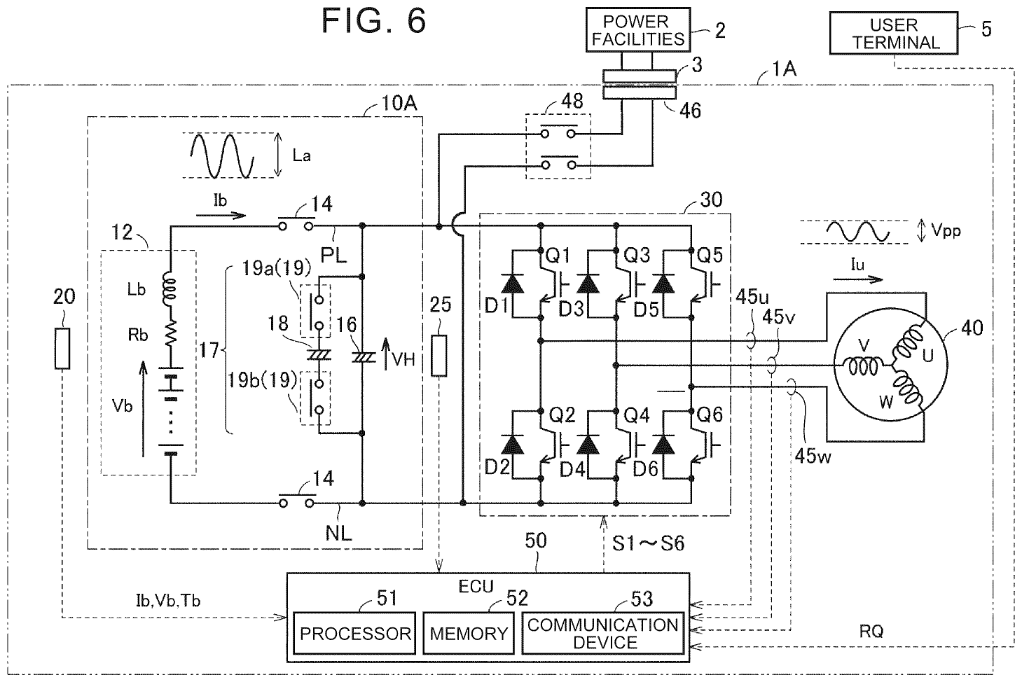

FIG. 6 is a diagram for explaining an overall configuration of a vehicle in Modification 1. Referring to FIG. 6, the vehicle 1A differs from the vehicle 1 (FIG. 1) in that it comprises an electric circuit 10A instead of the electric circuit 10, but is otherwise essentially the same as the vehicle 1. The electric circuit 10A differs from the electric circuit 10 in that it further comprises a circuit element 17.

The circuit element 17 is electrically connected in parallel to the capacitor 16 and includes a sub-capacitor 18 and a switch 19a, 19b (switch section 19). Only one of these switches may be provided. The sub-capacitor 18 is provided to compensate for an excessive decrease in capacitance when the capacitor 16 is deteriorated. The switches 19a, 19b is capable of switching the connection status (connection/disconnection) between the capacitor 16 and the sub-capacitor 18.

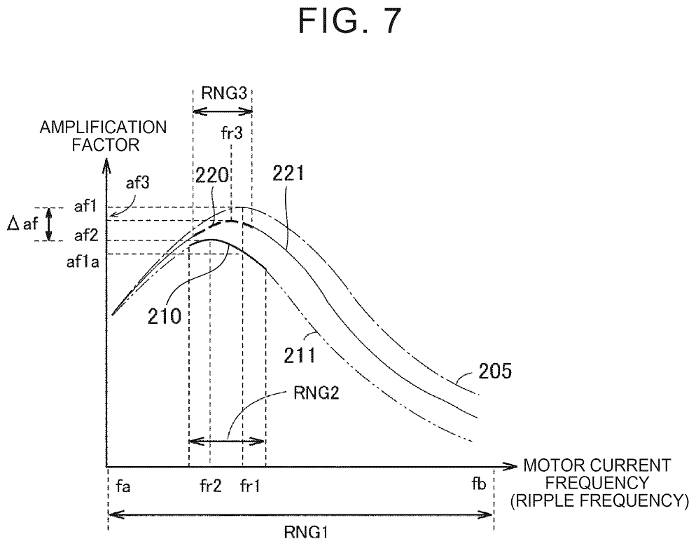

FIG. 7 is a diagram for explaining a method of searching for a resonance frequency and updating a set frequency in Modification 1. Referring to FIG. 7, this diagram is the same as FIG. 4A except that lines 220 (dashed lines) and lines 221 are added.

In Modification 1, as long as the magnitude of the difference between the amplification factor af (in this example, the reference amplification factor af2) at the resonance frequency searched for this time and the amplification factor af (in this example, the reference amplification factor af1) at the resonance frequency searched for last time is less than the threshold value (for example, Δaf in the illustrated FIG. 4A), the switches 19a, 19b is opened. As a result, the sub-capacitor 18 is electrically disconnected from the capacitor 16. Δaf is related to the amount of decrease in capacitance of the capacitor 16, and in this example, it is assumed that the amount of decrease in capacitance is larger as Δaf is larger. The relationship between Δaf and the capacity decrease amount is determined by, for example, a pre-evaluation test as a map, and is stored in the memory 52.

When Δaf is equal to or greater than the threshold value, the resonance characteristic (line 211) of the electric circuit 10 greatly changes from the characteristic (line 205) in the initial stage due to, for example, an excessive decrease in capacitance of the capacitor 16. In this case, even if the set frequency at the time of the ripple temperature increase control is updated from the reference frequency fr1 to the reference frequency fr2 (by increasing the amplification factor af from af1a to af2) and the amount of heat generated by the battery 12 is maximized, there is a possibility that the ripple amplitude La is small and the amount of heat generated by the battery 12 is insufficient. As a consequence, there is a possibility that the temperature of the battery 12 cannot be sufficiently raised as before the capacitance reduction of the capacitor 16 (when the set frequency is the reference frequency fr1 in the initial stage).

ECU 50 has a configuration for addressing such issues. Specifically, after the second search process and the second updating process, ECU 50 determines the capacitance reduction of the capacitor 16 according to Δaf using the map described above. When the capacitance decrease amount is equal to or greater than the reference amount, ECU 50 controls the switches 19a, 19b to be closed so that the sub-capacitor 18 is electrically connected to the capacitor 16 (switch switching control). When the capacity decrease amount is less than the reference amount, the switch switching control is not executed.

ECU 50 executes the third search process after the switching control. The third search process is a process of scanning the motor current frequency within the frequency range RNG3 to search for a reference frequency fr3 that is a motor current frequency at which the gain af is maximized in the frequency range RNG3. The frequency range RNG3 includes the reference frequency fr2 and is a range narrower than the frequency range RNG1, but differs from the frequency range RNG2. The technique for scanning the motor current frequency is the same as that described in FIGS. 4A to 4C, thereby deriving the relation (line 220) between the motor current frequency and the gain af within the frequency range RNG3. In Modification 1, the reference amplification factor af3, which is the amplification factor af that is maximized in the reference frequency fr3 in the third search process, is higher than the reference amplification factor af2. ECU 50 executes the third update process of updating the set frequency from the reference frequency fr2 to the reference frequency fr3 as the above-described update process.

According to the switch switching control, the connection state between the sub-capacitor 18 and the capacitor 16 is switched so that the sub-capacitor 18 is connected in parallel to the capacitor 16. As a result, the resonant property (the relationship between the ripple frequency and the amplification factor af) of the electric circuit 10 changes as if the capacitor 16 was replaced by a capacitor having a combined capacitance of the capacitance of the capacitor 16 and the capacitance of the sub-capacitor 18 (as if the capacitance of the capacitor 16 was recovered by the capacitance of the sub-capacitor 18). In this example, the resonance characteristic changes from line 210 to line 221. Further, according to the third search process and the third update process, the reference frequency fr3 is searched for, and the set frequency is updated to this frequency. As a result, the amplification factor af during the ripple temperature increase control increases from the reference amplification factor af2 to the reference amplification factor af3, and the ripple amplitude La increases. As a result, it is possible to avoid a situation in which the temperature of the battery 12 cannot be effectively increased due to an excessive decrease in the capacitance of the capacitor 16.

### Second Modified Example

The electric circuit 10A may comprise a plurality of circuit elements 17. The circuit elements 17 are provided in parallel to each other with respect to the capacitor 16. The capacitance of the sub-capacitor 18 of each circuit element 17 is smaller than the capacitance of the capacitor 16. ECU 50 can connect one or more of the plurality of sub-capacitors 18 to the capacitor 16 in parallel by switching the switching units 19 of the respective circuit elements 17. With such a configuration, ECU 50 can appropriately change the number of sub-capacitors connected in parallel to the capacitor 16 among the plurality of sub-capacitors 18, and thus can finely adjust the combined capacitance of the sub-capacitor and the capacitor 16.

### Other Variations

The search process of the resonance frequency after the first update process (for example, the second search process) is executed when the counter value reaches the threshold value. However, it may be executed, for example, when the traveling distance of the vehicle 1 reaches a predetermined threshold distance or when the age of use of the vehicle 1 reaches a predetermined threshold age.

The temperature rise starting condition may be that the communication device 53 receives the request RQ from the user terminal 5, or that the vehicle 1 is keyed-off. By setting the temperature rise start condition in this way, it is possible to appropriately raise the temperature of the battery 12 during parking and stopping of the vehicle 1 (external charging is not performed), and then start traveling of the vehicle 1.

It should be considered that the embodiments disclosed above are for illustrative purposes only and are not limitative of the disclosure in any aspect. It is intended that the scope of the disclosure be defined by the appended claims rather than the foregoing description, and that all changes within the meaning and range of equivalency of the claims be embraced therein.

What is claimed is:

1. An electrical system comprising:
an inverter;
an electric circuit including a power storage device and a capacitor, the capacitor being connected between a pair of power lines connecting the power storage device to the inverter; and
a control device configured to perform frequency control for controlling the inverter to cause a current frequency of an alternating current generated by the inverter to be a set frequency related to a resonance frequency of the electric circuit when a temperature increase start condition for starting to increase a temperature of the power storage device is satisfied, wherein the control device is configured to perform an update process for updating the set frequency to increase a ripple of a current flowing through the electric circuit when the frequency control is performed.

2. The electrical system according to claim 1, wherein the update process is performed to increase an amplification factor of a magnitude of the ripple with respect to a magnitude of the alternating current.

3. The electrical system according to claim 2, wherein:
the control device is configured to perform a first search process for searching for a first reference frequency that is the current frequency at which the amplification factor is maximized in a predetermined first frequency range by scanning the current frequency within the first frequency range; and
the update process includes a first update process for updating the set frequency to the first reference frequency.

4. The electrical system according to claim 3, wherein:
the control device is configured to, after the first update process, perform a second search process for searching for a second reference frequency that is the current frequency at which the amplification factor is maximized in a second frequency range by scanning the current frequency within the second frequency range, the second frequency range including the first reference frequency and narrower than the first frequency range; and
the update process further includes a second update process for updating the set frequency from the first reference frequency to the second reference frequency.

5. The electrical system according to claim 4, further comprising a circuit element electrically connected in parallel to the capacitor, wherein:
the circuit element includes a sub-capacitor and a switch configured to switch a connection state between the capacitor and the sub-capacitor;
the amplification factor includes a first reference amplification factor that is maximized at the first reference frequency in the first search process, and a second reference amplification factor that is maximized at the second reference frequency in the second search process, the second reference amplification factor being lower than the first reference amplification factor;
the control device is configured to determine a capacity decrease amount of the capacitor based on a magnitude of a difference between the second reference amplification factor and the first reference amplification factor;
the control device is configured to control the switch to connect the sub-capacitor to the capacitor when the capacity decrease amount is equal to or greater than a reference amount;
the control device is configured to, after the sub-capacitor is connected to the capacitor, perform a third search process for searching for a third reference frequency that is the current frequency at which the amplification factor is maximized in a third frequency range by scanning the current frequency within the third frequency range, the third frequency range including the second reference frequency and narrower than the first frequency range; and
the update process further includes a third update process for updating the set frequency from the second reference frequency to the third reference frequency.
